(19) United States
(12) Patent Application Publication
(10) Pub. No.: US 2011/0165412 A1
(43) Pub. Date: Jul. 7, 2011

(54) ADHESION LAYERS IN NANOIMPRINT LITHOGRAHY

(75) Inventors: Zhengmao Ye, Austin, TX (US); Frank Y. Xu, Round Rock, TX (US); Dwayne L. LaBrake, Cedar Park, TX (US); Kosta S. Selinidis, Austin, TX (US)

(73) Assignee: MOLECULAR IMPRINTS, INC., Austin, TX (US)

(21) Appl. No.: 12/954,376

(22) Filed: Nov. 24, 2010

Related U.S. Application Data
(60) Provisional application No. 61/264,100, filed on Nov. 24, 2009.

(51) Int. Cl. B32B 7/12; B05D 5/10; B05D 3/12

(52) U.S. Cl. 428/336; 427/208; 427/271

(57) ABSTRACT

Forming an adhesive layer on a nanoimprint lithography template or a double-sided disk. Forming the adhesive layer on the double-sided disk includes immersing the double-sided disk in a liquid adhesive composition and removing the double-sided disk from the adhesive composition. The outer layer of the double-sided disk is a carbon overcoating or an intermediate layer. The adhesive composition is dried to form a first adhesion layer adhered directly to the carbon overcoating or intermediate layer on a first side of the disk and a second adhesion layer adhered directly to the carbon overcoating or intermediate layer on a second side of the disk. Forming the adhesive layer on the nanoimprint lithography template includes applying an adhesive material to the template, allowing the template to remain motionless, and rinsing a portion of the adhesive material from the template with a solvent, and drying the template.

### CROSS-REFERENCE TO RELATED APPLICATION

Under 35 U.S.C. §119(e)(1), this application claims the benefit of prior U.S. Provisional Application No. 61/264,100, filed Nov. 24, 2009, which is hereby incorporated by reference herein in its entirety.

### TECHNICAL FIELD

The present invention relates to adhesion layers in nanoimprint lithography.

### BACKGROUND

Nano-fabrication includes the fabrication of very small structures that have features on the order of 100 nanometers or smaller. One application in which nano-fabrication has had a sizeable impact is in the processing of integrated circuits. The semiconductor processing industry continues to strive for larger production yields while increasing the circuits per unit area formed on a substrate, therefore nano-fabrication becomes increasingly important. Nano-fabrication provides greater process control while allowing continued reduction of the minimum feature dimensions of the structures formed. Other areas of development in which nano-fabrication has been employed include biotechnology, optical technology, mechanical systems, and the like.

An exemplary nano-fabrication technique in use today is commonly referred to as imprint lithography. Exemplary imprint lithography processes are described in detail in numerous publications, such as U.S. Patent Application Publication No. 2004/0065976, U.S. Patent Application Publication No. 2004/0065252, and U.S. Pat. No. 6,936,194, all of which are hereby incorporated by reference herein.

An imprint lithography technique disclosed in each of the aforementioned U.S. patent application publications and patent includes forming a relief pattern in a formable (polymerizable) layer and transferring a pattern corresponding to the relief pattern into an underlying substrate. The substrate may be coupled to a motion stage to obtain a desired positioning to facilitate the patterning process. The patterning process uses a template spaced apart from the substrate and the formable liquid applied between the template and the substrate. The formable liquid is solidified to form a rigid layer that has a pattern conforming to a shape of the surface of the template that contacts the formable liquid. After solidification, the template is separated from the rigid layer such that the template and the substrate are spaced apart. The substrate and the solidified layer are then subjected to additional processes to transfer a relief image into the substrate that corresponds to the pattern in the solidified layer. This technique may be applied to create multiple copies, or daughter masks, of a single master pattern. The daughter mask may be processed to have substantially the same or the inverse image of the master. In some cases, an adhesion layer is applied to a template with a mesa such that the master pattern is transferred to the daughter mask.

In some cases, a spin coating process is used to apply an adhesion layer on a mesa of a template. FIG. 1A illustrates a top view of an imprint lithography template 18 with mesa 20. FIG. 1B shows a cross-sectional view of the template, with mesa 20 extending from the top of the template. A dilute solution of adhesion primer is applied to the raised portion of the template, and spun to dryness to form an adhesion layer on the template. The adhesion primer that remains on the template forms covalent bonds with the surface of the template. The coated template may be baked to cure the adhesion primer on the surface of the template. When this process is applied to mesa 20 of template 18 with pre-existing topography, edge beads 2 are formed around the edges of the mesa, as illustrated in FIG. 2. Defects and coating non-uniformities can be particularly noticeable in corners of the mesa topography, due to the dynamics of the spin coating process which is most suitable for radial substrates. In some cases, these defects and non-uniformities in a spin coated layer over the topography of a mesa of a template may be acceptable if the care area does not include the spin coated defects. In some applications, such as a replication of a master pattern, the location of the edge bead and corner defects interfere with other processes required to transfer the master pattern to the daughter template, including the imprint and subsequent etching. Critical features near the mesa edge are adversely affected, and a standard spin coating process does not yield acceptable results.

Spin coating processes, developed for circular substrates, are inherently radial in nature. Spin coating square or rectangular substrates is known to yield a non-uniform coating outside a radial boundary. Coating can be substantially uniform within the radial boundary from the center to the closest edge, but non-uniformities can arise outside the radial boundary beyond the closest edge of topography. Spin coating defects located at the edges and corners of a rectangular mesa 20 are visible in the photograph (magnification 50) of the top of a spin coated template in FIG. 3, as indicated by the arrows. The defects may be attributed to excess material that builds up at the boundaries (e.g., edges) of the mesa due to factors such as surface tension forces, air flow dynamics, and drying effects.

### SUMMARY

In one aspect, coating a double-sided disk includes immersing a double-sided disk with a carbon overcoating on both sides of the disk in a liquid adhesive composition. The double-sided disk is removed from the liquid adhesive composition. The adhesive composition is dried to form a first adhesion layer adhered directly to the carbon overcoating on a first side of the disk and a second adhesion layer adhered directly to the carbon overcoating on a second side of the disk.

In another aspect, coating a double-sided disk includes immersing a double-sided disk comprising an intermediate layer over a carbon overcoating on both sides of the disk in a liquid adhesive composition. The double-sided disk is removed from the liquid adhesive composition. The adhesive composition is dried to form a first adhesion layer adhered directly to the intermediate layer on a first side of the disk and a second adhesion layer adhered directly to the intermediate layer on a second side of the disk.

In yet another aspect, a double-sided disk includes a carbon overcoating on each side of the disk, and an adhesion layer formed by dip coating. The adhesion layer is directly adhered to each carbon overcoating, and a thickness of each adhesion layer is between 2 nm and 4 nm.

In yet another aspect, coating a mesa on an imprint lithography template includes cleaning the surface of the template and applying adhesive material to the mesa such that the surface of the mesa and a surrounding portion of the template are substantially covered by the adhesive material. The template is allowed to remain substantially motionless for a length of time, during which time some of the adhesive material forms covalent bonds with the surface of the template, including the mesa. A portion of the adhesive material is then rinsed from the template with a solvent, wherein rinsing comprises spinning the template, and the template is dried.

Implementations include one or more of the following features. For example, coating a double-sided disk can further include disposing a first polymerizable material on the first adhesion layer, contacting the first polymerizable material with an imprint lithography template, polymerizing the first polymerizable material on the first adhesion layer to form a first patterned layer adhered to the first adhesion layer, and separating the imprint lithography template from the first patterned layer.

In some embodiments, the carbon overcoating includes amorphous-hydrogenated carbon (CHₓ) or amorphous-nitrogenated carbon (CNₓ). The carbon overcoating has some non-polar surface groups, such as carbonyl groups, hydroxy groups, and the like. The intermediate layer includes Ta, Si₃N₄, SiO₂, Cr, TiW, TiCr, Ru, SiN, or a combination thereof. In one example, the intermediate layer is tantalum, and an adhesive force between a solidified imprint resist the tantalum intermediate layer as measured in a shear test exceeds 45 lbf.

The adhesive composition includes a multi-functional reactive compound, and the multi-functional reactive compound includes a linker group and two or more functional groups. The functional groups are independently selected from the group consisting of carboxy, epoxy, acrylic, hydroxy, and methoxy groups. The multi-functional reactive compound adheres to the carbon overcoating, the intermediate layer, and/or the first polymerizable material by covalent bonding. In some cases, the multi-functional reactive compound includes a carboxy group, and the multi-functional reactive compound adheres to the carbon overcoating or intermediate layer by covalent bonding through the carboxy group. The multi-functional reactive compound adheres to the first polymerizable material by covalent bonding. In some cases, the multi-functional reactive compound includes an acrylic group or a methacrylic group, and the multi-functional reactive compound adheres to the first polymerizable material by covalent bonding through the acrylic group or the methacrylic group. The linker group of the multi-functional reactive compound can be —CH₂—.

In some implementations, a thickness of the first and second adhesion layers is between about 1 nm and about 5 nm, or between about 2 nm and about 4 nm, and a standard deviation of a thickness of the first and second adhesion layers is between about 0.5 nm and about 1.5 nm.

Thus, particular embodiments have been described. Variations, modifications, and enhancements of the described embodiments and other embodiments can be made based on what is described and illustrated. In addition, one or more features of one or more embodiments may be combined. The details of one or more implementations and various features and aspects are set forth in the accompanying drawings, the description, and the claims below.

### BRIEF DESCRIPTION OF THE DRAWINGS

FIGS. 1A and 1B illustrate views of an imprint lithography template with a mesa.

FIG. 2 is a cross-sectional view of an edge bead formed by a spin coating process on a mesa of an imprint lithography template.

FIG. 3 is a photograph of top view of a spin-coated imprint lithography template.

FIG. 4 illustrates a simplified side view of a lithographic system.

FIG. 5 illustrates a simplified side view of the substrate shown in FIG. 4 having a patterned layer positioned thereon.

FIGS. 6A-6D illustrate steps in a coating process for a rectangular mesa on an imprint lithography template.

FIG. 7 is a photograph of a top view of an imprint lithography template coated by the method according to FIGS. 6A-6D.

FIGS. 8A and 8B illustrate a shear test to assess a strength of an adhesive layer on a substrate.

FIG. 9 is a cross-sectional view of a portion of a double-sided disk.

FIG. 10 is a flow chart showing steps in a process of applying an adhesion layer to a double-sided disk.

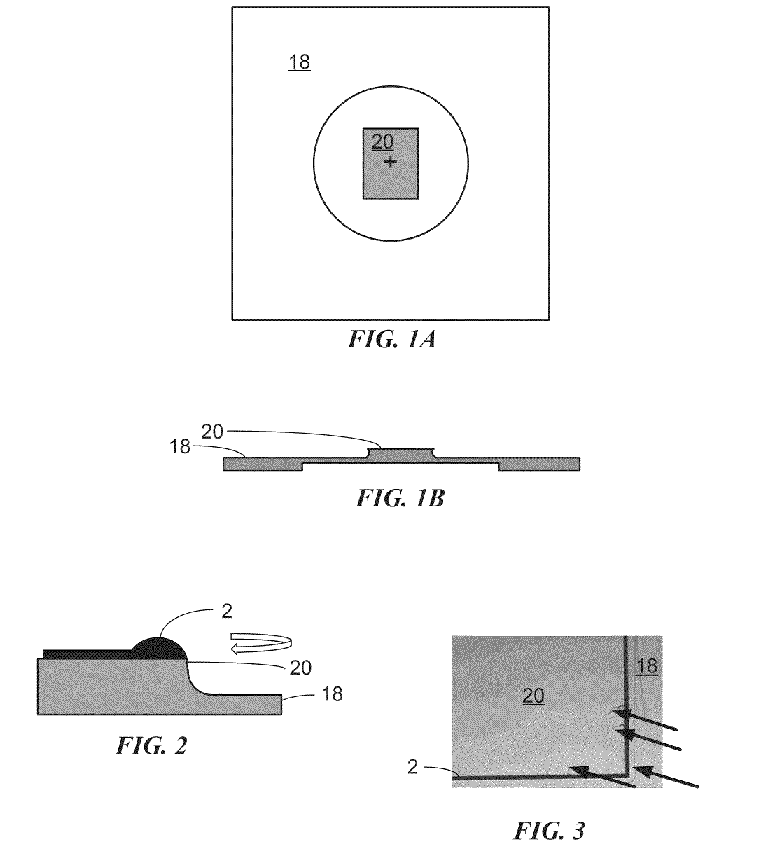

### DETAILED DESCRIPTION

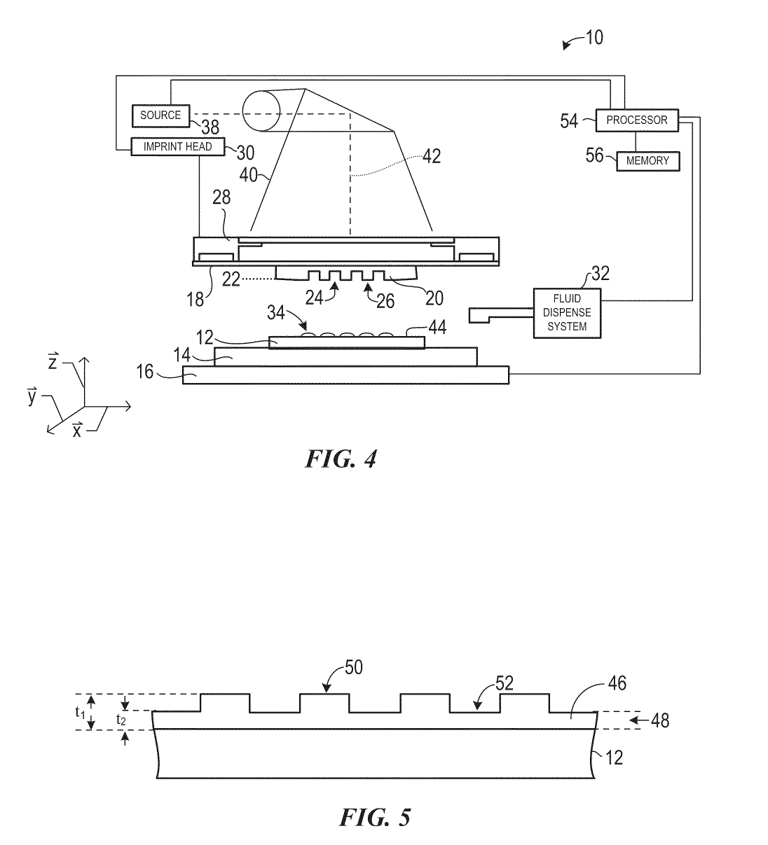

Referring to FIG. 4, illustrated therein is a lithographic system 10 used to form a relief pattern on substrate 12. Substrate 12 may be coupled to substrate chuck 14. As illustrated, substrate chuck 14 is a vacuum chuck. Substrate chuck 14, however, may be any chuck including, but not limited to, vacuum, pin-type, groove-type, electromagnetic, and/or the like. Exemplary chucks are described in U.S. Pat. No. 6,873,087, which is hereby incorporated by reference herein.

Substrate 12 and substrate chuck 14 may be further supported by stage 16. Stage 16 may provide motion about the x-, y-, and z-axes. Stage 16, substrate 12, and substrate chuck 14 may also be positioned on a base (not shown).

Spaced-apart from substrate 12 is a template 18. Template 18 generally includes a rectangular or square mesa 20, with dimensions up to about 150 microns, and extending about 10 microns to about 50 microns, or about 15 microns to about 20 microns from a surface of the template towards substrate 12. A surface of mesa 20 may include patterning surface 22. In some cases, mesa 20 is referred to as mold 20. Template 18 and/or mold 20 may be formed from such materials including, but not limited to, fused silica, quartz, silicon, silicon nitride, organic polymers, siloxane polymers, borosilicate glass, fluorocarbon polymers, metal (e.g., chrome, tantalum), hardened sapphire, or the like, or a combination thereof. As illustrated, patterning surface 22 includes features defined by a plurality of spaced-apart recesses 24 and/or protrusions 26, though embodiments are not limited to such configurations. Patterning surface 22 may define any original pattern that forms the basis of a pattern to be formed on substrate 12.

Template 18 may be coupled to chuck 28. Chuck 28 may be configured as, but not limited to, vacuum, pin-type, groove-type, electromagnetic, and/or other similar chuck types. Exemplary chucks are further described in U.S. Pat. No. 6,873,087, which is hereby incorporated by reference herein. Further, chuck 28 may be coupled to imprint head 30 such that chuck 28 and/or imprint head 30 may be configured to facilitate movement of template 18.

System 10 may further comprise a fluid dispense system 32. Fluid dispense system 32 may be used to deposit polymerizable material 34 on substrate 12. Polymerizable material 34 may be positioned upon substrate 12 using techniques such as drop dispense, spin-coating, dip coating, chemical vapor deposition (CVD), physical vapor deposition (PVD), thin film deposition, thick film deposition, and/or the like. Polymerizable material 34 may be disposed upon substrate 12 before and/or after a desired volume is defined between mold 20 and substrate 12 depending on design considerations. Polymerizable material 34 may include a monomer as described in U.S. Pat. No. 7,157,036 and U.S. Patent Application Publication No. 2005/0187339, all of which are hereby incorporated by reference herein.

Referring to FIGS. 4 and 5, system 10 may further include an energy source 38 coupled to direct energy 40 along path 42. Imprint head 30 and stage 16 may be configured to position template 18 and substrate 12 in superimposition with path 42. System 10 may be regulated by a processor 54 in communication with stage 16, imprint head 30, fluid dispense system 32, and/or source 38, and may operate on a computer readable program stored in memory 56.

Either imprint head 30, stage 16, or both vary a distance between mold 20 and substrate 12 to define a desired volume therebetween that is filled by polymerizable material 34. For example, imprint head 30 may apply a force to template 18 such that mold 20 contacts polymerizable material 34. After the desired volume is filled with polymerizable material 34, source 38 produces energy 40, e.g., broadband ultraviolet radiation, causing polymerizable material 34 to solidify and/or cross-link conforming to shape of a surface 44 of substrate 12 and patterning surface 22, defining a patterned layer 46 on substrate 12. Patterned layer 46 may comprise a residual layer 48 and a plurality of features shown as protrusions 50 and recessions 52, with protrusions 50 having a thickness t1 and residual layer 48 having a thickness t2.

The above-described system and process may be further implemented in imprint lithography processes and systems referred to in U.S. Pat. Nos. 6,932,934; 7,077,992; 7,197,396; and 7,396,475, each of which is hereby incorporated by reference herein.

As described herein, a substantially uniform and defect-free coating may be applied with spin coating equipment to patterned mesa 20 of imprint lithography template 18, such that the coated mesa is substantially free from buildup at the edges and corners of the mesa surface. In an example, the coating is an adhesion layer, and the coated template may be used with mask replication imprint lithography processing.

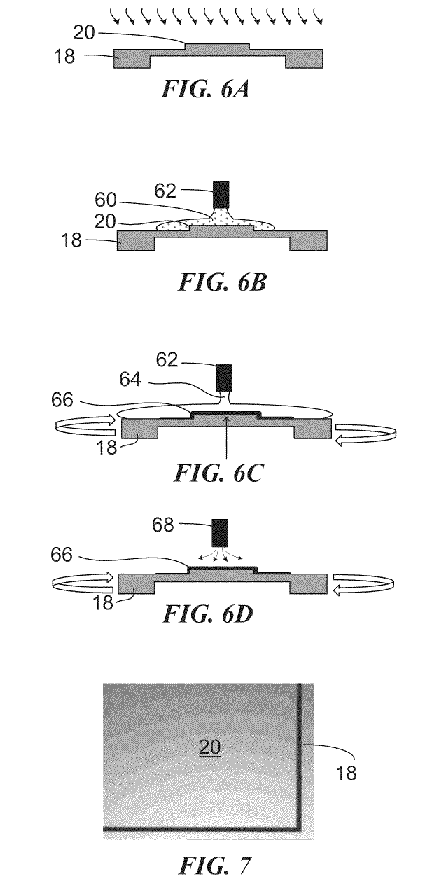

FIGS. 6A-6D illustrate a process for coating mesa 20 of imprint lithography template. In FIG. 6A, the template is cleaned to remove contaminants, including particulate matter, and to adjust a pH of the surface. Cleaning may include, for example, cleaning with a solution (e.g., a Standard Clean 1 (SC-1) solution of ammonium hydroxide and hydrogen peroxide), with a UV-ozone treatment, or a combination thereof. In FIG. 6A, the arrows represent radiation (e.g., UV radiation). A length of UV-ozone treatment may vary based on the power of the UV source. In an example, a UV-ozone treatment with a duration of about 10 minutes is performed after an SC-1 clean. In some cases, cleaning may include heating. Cleaning may yield a surface with a pH near neutral. The cleaned surface includes surface hydroxyl groups.

In FIG. 6B, adhesive material 60 is applied to template 18 with dispenser 62. The volume of adhesive material may be, for example, in a range from about 1 mL to about 5 mL, or about 3 mL. The adhesive material is allowed to remain substantially undisturbed (e.g., substantially motionless) on the template for a length of time, for example, from about 5 sec to about 5 min, or about 3 min. During this time, the template, the adhesive material, or both may be heated. Heating may increase the rate of bonding of the adhesive material to the surface of the template. Heating may also promote leveling of the adhesive material on the mesa, the template, or both.

Adhesive material 60 can include adhesion layer compositions described in U.S. Patent Application Publication No. 2007/0212494, which is hereby incorporated by reference herein. The adhesive material forms strong bonds with the template, and includes one or more components. In some embodiments, the adhesive material includes one component and moisture (H2O) from the atmosphere that may be used, for instance, in a hydrolysis reaction. Adhesion between the adhesive material and the template is achieved through various mechanisms, including covalent bonds, ionic bonds, van der Waals forces, or any combination thereof.

In some embodiments, an adhesive material includes one or more components generally represented as follows:

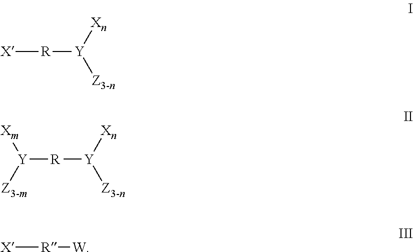

The adhesive material may include components I, II, or III or combinations thereof. Components I, II, and III include a first end, a second end, and a linker group (R, R′, R″). For instance, in components I and II, the first end may be thought of as including YXnZ3-n, while the first end of component III may be thought of as including W. Similarly, in components I and III, the second end may be thought of as including X′.

In components I and III above, X′ is a functional group that bonds covalently with a polymerizable material during activation such as, for instance, UV irradiation. For an acrylate-based polymerizable material, X′ may be, for instance, an acrylic group or a methacrylic group. In some cases, X′ includes two or more functional groups, with a first functional group that bonds covalently with the polymerizable material (e.g., acrylic or methacrylic group) and a second functional group (e.g., hydroxy or methoxy group) that reacts with another component in the adhesive material to polymerize and/or cross-link the adhesive material during formation of the adhesion layer.

In components I, II, and III above, Y is a tetravalent atom including, but not limited to, Si. Thus, the adhesive material can be a silicon-containing material. X is a functional group (for instance, a leaving group) which allows the Y—X bond to be hydrolyzed to Y—OH. The hydroxyl group may subsequently react with the template to form a covalent bond with the template. In embodiments in which Y is Si, X may be, for instance —OCH3, —OCH2CH3, —Cl, —OC(═O)CH3, etc. In components I, II, and III, n and m range from 1 to 3, inclusive. A higher number of leaving groups (for instance, n=3 and/or m=3) may allow for multiple bonding to a template and/or to other molecules in the adhesive material, increasing the strength of adhesion of the adhesive material to the template.

In components I, II, and III above, Z is generally an unreactive group which fulfills the tetravalent requirement of Y. In some embodiments, Z may be, for instance, a methyl group.

In components I, II, and III above, W is an acidic functional group that may react or interact with (e.g., form ionic or covalent bonds with) the template. In some embodiments, W is, for instance, carboxylic acid, phosphoric acid, or the like.

In components I, II, and III above, R, R′, and R″ are linker groups with different lengths. The linkers can be hydrocarbon based and can include, for example, 1-10 or more carbon atoms (alkyl groups, alkenyl groups, aryl groups). A linker group may be chosen for a variety of factors including, but not limited to length, rigidity, and/or bond strength(s) of the linker group. In some cases, a shorter linker group, such as methyl, provides greater adhesive strength. In certain cases, R, R′, and/or R″ may include a functional group that interacts with another component in the adhesive material to polymerize and/or cross-link the adhesive material during formation of the adhesion layer.

In components I and II above, X is selected to achieve cross-reaction of an end of component I and II (for instance, the first end) with the material from which the template is formed (e.g., the surface of the template) to adhere thereto by forming a covalent bond therewith, ionic bond therewith, and/or van der Waals interactions with the surface of the template. This may be achieved directly or indirectly. That is, if X is a leaving group, X does not directly react with the surface of the template. In this embodiment, a chemical reaction involving the leaving of X allows Y to chemically react to form a covalent bond with the surface of the template.

In some embodiments, functional groups X participate in the cross-linking and polymerization reactions of the adhesive material. The X functional groups facilitate polymerization and cross-linking in response to an activation energy that differs from the activation energy in response to which the X′ functional groups cross-react. In an example, the X functional groups facilitate cross-linking of molecules in the adhesive material in response to exposure to thermal energy. Functional groups X are selected to facilitate cross-reaction with the template through mechanisms including, but not limited to: 1) direct reaction with the template surface; and 2) reaction with cross-linker molecules, with a linking functional group of the cross-linker reacting with the substrate; and 4) leaving of X to allow Y to achieve 1) and 2) above. In some cases, X includes two or more functional groups, with a first functional group that bonds with the template (e.g., a carboxy group and/or an epoxy group) and a second functional group (e.g., a hydroxy or methoxy group) that reacts with another component in the adhesive material to polymerize and/or cross-link the adhesion layer formed from the adhesive material.

An exemplary multi-functional reactive compound A used in an adhesive material for a template includes acryloxymethyltrimethoxysilane (Gelest, Inc., Morristown, Pa.). Acryloxymethyltrimethoxysilane has the following structure:

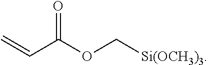

The X′ functional group provides acrylic functionality. The X functional group (n=3) is a methoxy leaving group bound to Y (tetravalent Si). Functional groups X and X′ are coupled to opposing ends of a backbone component or linker group with one carbon atom.

A short backbone component holds the X′ and X functional groups together more securely. Therefore, a shorter backbone component can provide a stronger adhesive material. In some embodiments, acryloxymethyltriethoxy-silane, with a —CH2- backbone component, is used as multi-functional reactive compound I.

Another multi-functional reactive compound I that can be used as an adhesive material for a template includes acryloxypropyltrichlorosilane (Gelest, Inc.) with the following structure:

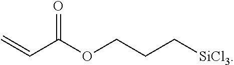

The X′ functional group provides acrylic functionality. The X functional group (n=3) includes three —Cl leaving groups bound to Y (tetravalent Si). Functional groups X and X′ are coupled to opposing ends of a backbone component with three carbon atoms.

Another multi-functional reactive compound I that can be used as an adhesive material includes acryloxypropyltrimethoxysilane (Aldrich; Milwaukee, Wis.) with the following structure:

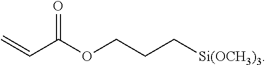

The X′ functional group provides acrylic functionality. The X functional group (n=3) includes three methoxy leaving groups bound to Y (tetravalent Si). Functional groups X and X′ are coupled to opposing ends of a backbone component with three carbon atoms.

A multi-functional reactive compound II that can be used to form an adhesive material on a template is 1,2-bis(trimethoxysilyl)ethane (Aldrich), with the following structure:

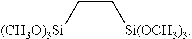

The X functional groups (m=3) include three methoxy leaving groups bound to Y (tetravalent Si). Functional groups X are coupled to opposing ends of a backbone component with two carbon atoms.

A multi-functional reactive compound II that can be used as an adhesive material on a template is 1,6-bis(trichlorosilyl)hexane (Aldrich), with the following structure:

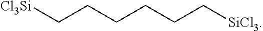

The X functional groups (m=3) and (n=3) include three —Cl leaving groups bound to Y (tetravalent Si). Functional groups X are coupled to opposing ends of a backbone component with six carbon atoms.

A multi-functional reactive compound III that can be used as an adhesive material is acrylic acid (Aldrich), with the following structure:

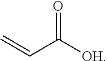

In an embodiment, components I, II, and/or III in the fluid state are contacted with a template during a coating process to adhere an adhesive material to a template. An adhesive material may include, for instance, I but not II and III; III but not I and II; I and II but not III; I and III but not II; or I, II, and III. When II is used along with I, the X functionality in II allows II to serve as a chain extender for co-polymerization of I and II.

In an embodiment, a component of an adhesive material is contacted with a surface of a template. Initiation of a chemical reaction between the adhesive material and the template can allow a first end of component I and/or component II and/or the W functional group of component III to bond (e.g., covalently or ionically) or interact (e.g., through van der Waals forces) with the template. In certain embodiments, for instance when the adhesive material includes acryloxymethyltrimethoxysilane or acryloxypropyltrimethoxysilane, the components bond to each other (as well as to the template) to form a networked polymer coating on the surface of the template. In embodiments in which the adhesive material includes I and II, co-polymerization of I and II may enhance the networked polymer coating of the adhesive material.

Initiation of the chemical reaction may be achieved, for instance, through heating of the adhesive material and/or the template. In some embodiments, a method of initiating the chemical reaction between the adhesive material and the template (for instance, between a first end of component I and/or component II after removal of leaving group(s) X) and/or a first end (W) of component III and the surface of the template), does not affect the X′ functionality of components of the adhesive material. For instance, heating of the adhesive material may cause bonding of a first end of components I, II, or III to a surface of a template, directly or indirectly through functional groups, without causing a reaction of a second end of components I or III (that is, without altering the X′ functionality).

Components of an adhesive material may be chosen for factors including, but not limited to, functionality (multi-functional or mono-functional), linker group length, linker rigidity, link bond strength(s), pH, cross-linking density, reactivity, shelf life and/or stability, and boiling temperature. The strength of the adhesive material may be limited by properties of the linker group (for instance, the weakest bond in the linker group). Thus, a component may be chosen to have a short linker with a strong bond between X and X′ functionalities.

While in contact with the template, silane groups in the adhesive material (e.g., the silane in components I, II, and/or III) undergo condensation reactions with hydroxyl groups on the surface of the template to form covalent bonds with the surface. In some cases, the template or the adhesive material is heated to promote reaction of the adhesive material with the surface.

After the adhesive material is allowed to remain substantially undisturbed on the surface of the motionless template for a length of time, a solvent (e.g, isopropyl alcohol (IPA), or propylene glycol methyl ether acetate (PGMEA)), is used to rinse the excess adhesive material away from the template, leaving the adhesive material that is chemically bonded to the surface. As shown in FIG. 6C, a volume of solvent 64 is applied to template 18 through dispenser 62. In an example, the volume of solvent 64 applied to the template may be in a range between about 5 mL and about 50 mL. In some cases, the volume of solvent applied to template 18 is about 10 mL. During application of the solvent, the template 18 is rotated (e.g., in single wafer spin equipment) such that the solvent substantially removes the unbonded adhesive material 60 from the surface of the mesa. A rotation rate of the template may be at least about 100 rpm and less than about 1500 rpm. The rotation rate is selected such that the unbonded adhesive material is substantially removed without stripping bonded adhesive layer 66 from the mesa (e.g., from the corners of the mesa).

After excess solvent is rinsed from the template, the template is dried, as shown in FIG. 6D. The template may be dried by flowing gas (e.g., air, nitrogen, or the like) through dispenser 68. The gas may be de-ionized, filtered, or both. In some cases, the template is spun with or without the presence of airflow to promote drying. In certain cases, the template is heated to promote drying. The solvent is substantially removed during drying, and leaves little or no residue on the template. After drying, the template may be post-baked. In some cases, post-baking helps drive off any remaining solvent, improve adhesion, or both.

By chemically reacting the adhesive material with the surface (FIG. 6B), and then removing the excess adhesion material with solvent (FIG. 6C), defects that result from spinning an adhesive composition to dryness can be avoided. FIG. 7 is a photograph (magnification 50×) of a top view of a template coated by the process described in FIGS. 6A-6D. FIG. 7 shows clean mesa edges and corners, especially in comparison to the defects and non-uniformities of the spin coated layer on the template shown in FIG. 3.

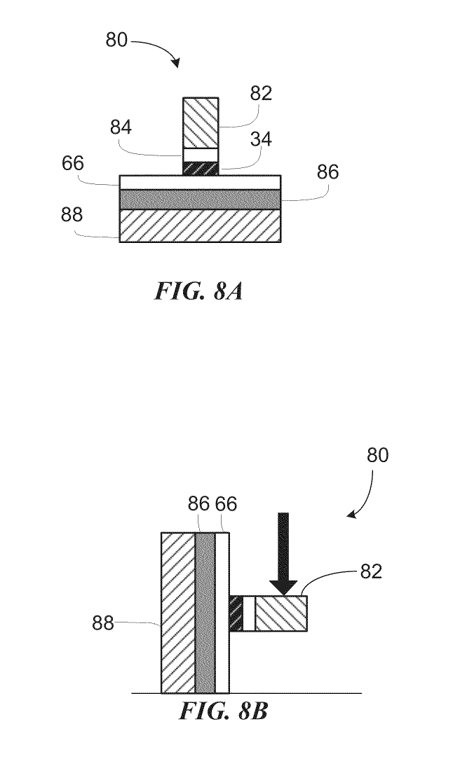

An adhesion test was conducted by coating a chromium surface on a glass substrate with an adhesive material as shown in FIGS. 6A-6D. FIG. 8A illustrates the assembly 80 configured for the adhesion test. The end of a glass rod 82 (5 mm diameter) was brush coated with a strong adhesive 84 to ensure that shearing would occur at substrate 86. Substrate 86 (e.g., template 18) was adhered to support 88 for the test. A drop of imprinting material 34 was placed between the adhesion layer 66 on the substrate and the end of the glass rod 82. The glass rod 82 was positioned on the substrate 86 such that the glass rod was substantially perpendicular to the lateral plane of the substrate. The imprinting material 34 was cured with ultraviolet radiation.

With the glass rod 82 anchored on the substrate 86, shear testing of the glass rod was performed to assess adhesion of the glass rod to the substrate. As shown in FIG. 8B, the assembly 80 was supported such that the glass rod 82 was substantially horizontal. An Instron anvil (available from Instron Worldwide Headquarters, Norwood, Mass.) was used to push vertically down on the rod 82, as shown by the arrow, until separation occurred. That is, the adhesion force was recorded as the force required to shear the glass rod from the substrate at the adhesion layer 66. An average adhesion force of 33.5 lbf (standard deviation of 1.9) was measured for four test samples.

As a comparison, the same shear test performed on a similar substrate in the absence of the adhesion layer 66 required a shear force between about 1 lbf and about 10 lbf. The adhesive properties of the surface measured by this shear force testing demonstrate that an adhesive layer remains after completion of the solvent rinse and dry shown in FIGS. 6C and 6D.

### Double-Sided Coating

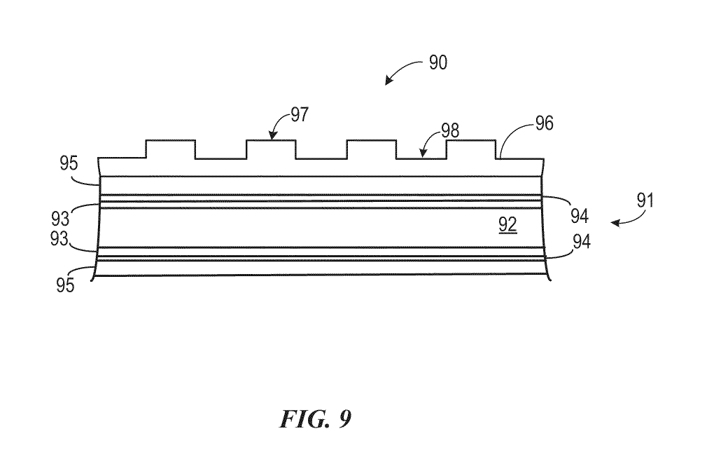

In an imprint lithography process, an adhesion layer may be deposited on the surface of a substrate, or on two or more surfaces of a substrate (e.g., a double-sided disk or wafer) to provide adhesion between the surface of one or more outer layers of the substrate and, for example, a polymerizable material applied to the substrate. FIG. 9 shows a cross-sectional view of a portion of a double-sided disk 90. Disk 90 includes substrate 91. Substrate 91 includes support 92 and one or more layers or coatings, including overcoating 93, intermediate layer 94, or both. Adhesion layer 95 is formed on the outer layers of substrate 91 and, in some cases, between outer layer of substrate 91 and patterned layer 96. Patterned layer 96 may be formed on both sides of disk 90. As shown in FIG. 9, patterned layer 96 includes protrusions 97 and recessions 98.

In some cases, when an outer layer of the disk 90 is a substantially non-polar carbon overcoating (e.g., amorphous-hydrogenated carbon (CHx) or amorphous-nitrogenated carbon (CNx), with some non-polar surface groups, e.g., carbonyl groups, hydroxy groups, etc.), adhesion to the carbon overcoating may be limited, and an intermediate layer (e.g., Ta, Si3N4, SiO2, Cr, TiW, TiCr, Ru, SiN, and the like) is applied to the carbon overcoating before the adhesion layer is applied. In an example, a thickness of an intermediate layer is between 3 nm and 15 nm. This process is described in U.S. Patent Application Publication No. 2010/0112236, which is incorporated herein by reference.

Various types of carbon overcoatings are used in hard disk drive (HDD) industry as a protection layer for magnetic disks. For patterned media, a carbon overcoating may be the outer layer prior to adhesion layer deposition. Multi-functional reactive compounds describe herein advantageously form covalent bonds with carbon overcoatings through the non-polar surface groups, thus allowing an adhesive material to bond directly to a carbon overcoating layer through a functional group (e.g., a carboxy group). Following adhesion layer deposition on a carbon overcoating or intermediate layer, an imprint resist may be applied to the adhesion layer and imprinted in an imprinting process as described herein.

As used herein, an imprint resist can be an acrylate-containing imprint resist. An acrylate imprint resist can include isobornyl acrylate (20-80 wt %), n-hexyl acrylate (0-50 wt %), ethylene glycol diacrylate (10-50 wt %), and 2-hydroxy-2-methyl-1-phenyl-propan-1-one (1-5 wt %), as described in U.S. Pat. No. 7,759,407. One example of an acrylate-containing imprint resist includes include 47 wt % isobornyl acrylate, 25 wt % n-hexyl acrylate, 25 wt % ethylene glycol diacrylate, and 3 wt % 2-hydroxy-2-methyl-1-phenyl-propan-1-one.

Application of an adhesion layer to an imprint lithography template by spin coating may result in an edge bead 2 (shown in FIG. 2) that causes non-conformal contact between the template and the disks during an imprinting process. Furthermore, spin coating processes are impractical when double-sided coating is needed, as with media disks. As described herein, an adhesion layer with a composition such as those described in U.S. Patent Application Publication No. 2007/0017631 and U.S. Pat. No. 7,759,407, both of which are hereby incorporated by reference herein, may be applied simultaneously to both sides of a double-sided disk with a carbon overcoating or an intermediate coating.

Referring to FIG. 9, adhesion layer 95 is formed from a composition that forms strong bonds at the interface between adhesion layer 95 and patterned layer 96, as well as strong bonds at the interface between adhesion layer 95 and an outer layer of substrate 91. Adhesion between adhesion layer 95 and patterned layer 96 is characterized by covalent bonds between the composition from which adhesion layer 95 is formed and the polymerizable material from which patterned layer 96 is formed. Adhesion between adhesion layer 95 and substrate may be achieved through any one of various mechanisms, including covalent bonds, ionic bonds, van der Waals interactions, or a combination thereof formed between the composition from which adhesion layer 95 is formed and an outer layer of substrate 91.

This adhesion is achieved by forming adhesion layer 95 from a composition that includes a multi-functional reactive compound, i.e., a compound that contains two or more (e.g., three or four) functional groups, generally represented as follows:

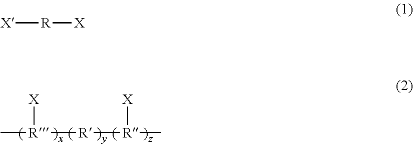

in which R, R′, R″ and R′″ are linking groups and x, y, z are averaged repeating numbers of the groups associated therewith. These repeating units can be randomly distributed. In certain cases, R, R′, R″, and/or R′″ may include a functional group (e.g., hydroxy or methoxy) that interacts with another component in the adhesive material to polymerize and/or cross-link the adhesive material during formation of the adhesion layer. The groups X and X′ denote the functional groups, with the understanding that typically, the functional group X differs from functional group X′. One of the functional groups X and X′, for example X, is selected to achieve cross-reaction with the outer layer of substrate 91 and adhere thereto by forming a covalent bond, ionic bond and/or van der Waals interaction therewith. In some cases, X includes a carboxy group. One of the remaining functional groups X and X′, for example X′, is selected to achieve cross-reaction with the material from which patterned layer 96 is formed to form a covalent bond therebetween.

In some cases, one or both of X and X′ may include more than one functional group. For example, X and/or X′ may include two functional groups, where a first functional group bonds or interacts with the substrate or polymerizable material, respectively, and a second functional group (e.g., a hydroxy or methoxy group) reacts with another component in the adhesive material to polymerize and/or cross-link the adhesion layer formed from the adhesive material.

The functionality of the X′ group is established so the cross-reaction occurs during polymerization of patterned layer 96. As a result, the selection of functional group X′ depends upon the characteristics of the material from which patterned layer 96 is formed (i.e., it is desired that functional group X′ reacts with the functional groups of the composition from which patterned layer 96 is formed. For example, if patterned layer 46 is formed from a composition including acrylate monomers, X′ may include one or more of acrylic, vinyl ether, and or alkoxyl functional groups, and/or functional groups that copolymerize with acrylic groups in patterned layer 96. As a result, X′ functional groups cross-react in response to ultraviolet actinic energy.

Functional groups X may also participate in the cross-linking and polymerization reactions of adhesion layer 95. X functional groups can facilitate polymerization and cross-linking in response to an actinic energy that differs from the actinic energy in response to which X′ functional groups cross-react. The X functional groups in the present example facilitate cross-linking of molecules in adhesion layer 95 in response to exposure to thermal energy. Functional groups X can be selected to facilitate cross-reaction with the outer layer of substrate 91 through three mechanisms: 1) direct reaction with material from which the outer layer of substrate 91 is formed; 2) reaction with cross-linker molecules with a linking functional group of the cross-linker reacting with the outer layer of substrate 91; and 3) polymerization of and cross-linking of adhesion layer 95 so that chains of molecules of sufficient length may be developed to connect between patterned layer 96 and outer layer of substrate 91.

An exemplary multi-functional reactive compound that may be employed to form adhesion layer 95 in the presence of patterned layer 96 being formed from an acrylate-containing imprint resist includes a R-carboxyethyl acrylate, available from UCB Chemicals in Smyrna, Ga. under the product name β-CEA. β-CEA is an aliphatic compound having the following structure:

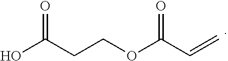

The X functional group provides carboxylic functionality. The X′ functional group provides acrylate functionality. The X and X′ functional groups are coupled to opposing ends of a backbone component.

Another multi-functional reactive compound that can be used to form adhesion layer 95 in the presence of patterned layer 96 being formed from an acrylate-containing resist includes an aromatic bis-phenyl compound available from UCB Chemicals in Smyrna, Ga. under the product name Ebecryl 3605 that has the following structure:

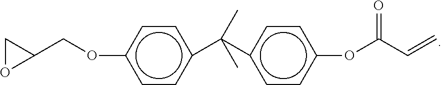

The X functional group provides epoxy functionality. The X′ functional group provides acrylate functionality. The X and X′ functional groups are coupled to opposing ends of a backbone component.

Another multi-functional reactive compound that can be used to form adhesion layer 95 in the presence of patterned layer 96 being formed from an acrylate-containing imprint resist includes an aromatic compound available from Schenectady International, Inc. in Schenectady, N.Y. under the product name Isorad 501 that has the following structure:

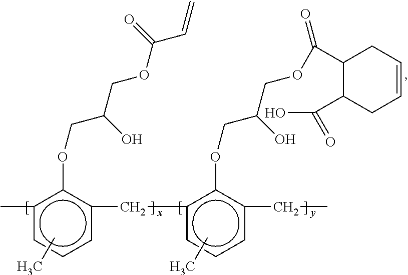

where x and y are integers indicating repeating units that are randomly distributed. The X functional group provides carboxylic and hydroxy functionality and the X′ functional group provides acrylate functionality, for a total of three functional groups. The X and X′ functional groups are coupled to opposing ends of a backbone component.

In addition to cross-reaction with patterned layer 96, functional group X′ may generate radicals that facilitate polymerization of the composition from which patterned layer 96 is formed during solidification of the same. As a result, the functional group X′ would facilitate polymerization of patterned layer 96 upon exposure to actinic energy, e.g., broad band ultraviolet energy. An exemplary multi-functional reactive compound that includes these properties is a photo-initiator available from Ciba Specialty Chemicals in Tarrytown, N.Y. under the tradename Irgacure 2959 and has the following structure:

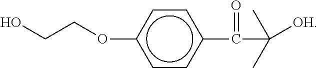

The X functional group provides hydroxyl functionality. The X′ functional group provides initiator-type functionality. Specifically, in response to exposure to broad band ultraviolet energy the functional group X′ undergoes alpha-cleavage to generate benzoyl radicals. The radicals facilitate radical polymerization of the composition from which patterned layer 96 is formed. The X and X′ functional groups are coupled to opposing ends of a backbone component.

Several compositions were formed including some of the aforementioned the multi-functional reactive compounds to determine the adhering strength of the interface between the adhesion layer 95 and the outer layer of substrate 91 and the interface between the adhesion layer 95 and the patterned layer 96. A composition including a multi-functional reactive compound is as follows:

### Composition 1

### β-CEA

### DUV30J-16

where COMPOSITION 1 includes 100 grams of DUV30J-16 and 0.219 grams of β-CEA. DUV30J-16 is a bottom anti-reflective coating, BARC, available from Brewer Science in Rolla, Mo. containing 93% solvent, and 7% non-solvent reactive components. DUV30J-16 contains phenolic resins, and its cross-linker can react with carboxylic functional groups. It is believed that DUV30J-16 does not form covalent bonds with patterned layer 96.

In another composition, β-CEA was replaced by a cross-linking agent, a catalyst and IsoRad 501. Both the cross-linking agent and catalyst are sold by Cytec Industries, Inc. of West Patterson, N.J. The cross-linking agent is sold under the product name Cymel 303ULF. One of the main components of Cymel 303ULF is hexamethoxymethyl-melamine (HMMM). The methoxyl functional groups of HMMM can participate in many condensation reactions. The catalyst is sold under the product name Cycat 4040 providing the following composition:

### Composition 2

### DUV30J-16

### Isorad 501

### Cymel 303ULF

### Cycat 4040

COMPOSITION 2 includes 100 grams of DUV30J-16, 0.611 gram of IsoRad 501, 0.175 gram of Cymel 303ULF, and 0.008 gram of Cycat 4040.

Another composition that can be used as the multi-functional reactive compound omits DUV30J-16. The composition is as follows:

### Composition 3

### IsoRad 501

### Cymel 303ULF

### Cycat

### PM Acetate

COMPOSITION 3 includes 77 grams of IsoRad 501, 22 grams of Cymel 303ULF, and 1 gram of Cycat 4040. The IsoRad 501, Cymel 303ULF and Cycat are combined, and then introduced into 1900 grams of PM Acetate. PM Acetate is a product name of a solvent consisting of 2-(1-methoxy)propyl acetate sold by Eastman Chemical Company of Kingsport, Tenn.

COMPOSITION 4 includes the same components as COMPOSITION 3 in different amounts: 85.2 grams of IsoRad 501, 13.8 grams of Cymel 303ULF, and 1 gram of Cycat 4040. The IsoRad 501, Cymel 303ULF and Cycat are combined, and then introduced into 1900 grams of PM Acetate.

COMPOSITION 5 includes the same components as COMPOSITION 3 in different amounts: 81 grams of IsoRad 501, 18 grams of Cymel 303ULF, and 1 gram of Cycat 4040. IsoRad 501, Cymel 303ULF and Cycat are combined, and then introduced into approximately 1900 grams of PM Acetate.

In some embodiments, photo-resist solvents other than PM Acetate may be used, such as diethylene glycol monoethyl ether acetate, methyl amyl ketone, or the like. Further, the solid contents of COMPOSITIONs 3-5, i.e., IsoRad 501, Cymel 303ULF, and Cycat may comprise between 0.1% and 70% by weight of the composition, or between 0.5% and 10% by weight, with the remaining quantity consisting of the solvent. The solid component of each of COMPOSITIONS 3-5 may comprise 50% to 99% by weight of IsoRad 501, 1% to 50% by weight of Cymel 303ULF, and 0% to 10% by weight of Cycat 4040.

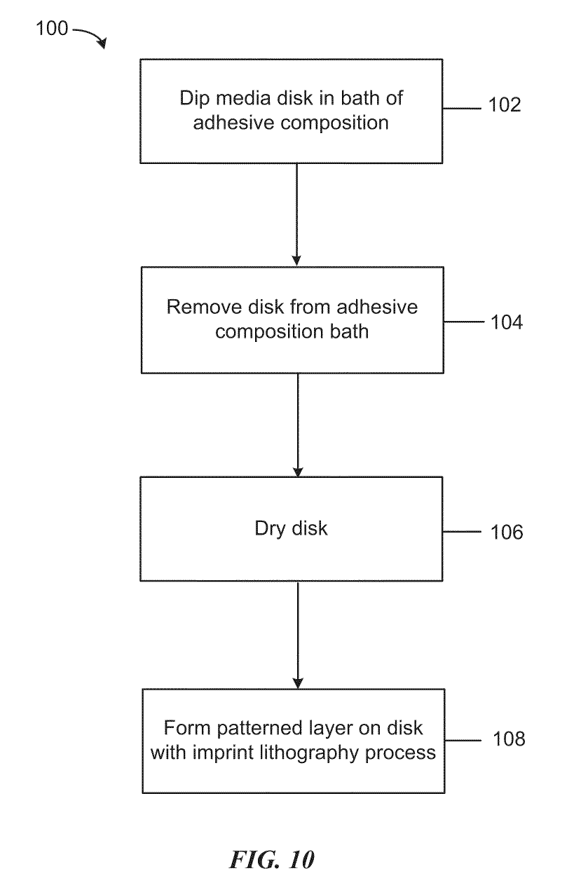

FIG. 10 is a flow chart that illustrates steps in an adhesion layer application process 100. In step 102, a media disk is dipped in a bath of adhesive composition for a length of time (e.g., less than 60 sec). The adhesive composition may be, for example, an adhesive composition described herein. The disk may be vertically oriented. In some cases, the disk is suspended by an edge of the opening in the center of the disk without interfering with the coating process on either side of the disk. In step 104, the disk is pulled out of the adhesive composition bath (e.g., vertically). A well-controlled pull-up speed contributes to coating uniformity of both sides of the disk. In step 106, the adhesive composition on the disk is allowed to dry. In some cases, drying is facilitated by flowing pressurized gas (e.g., air or nitrogen) over the disk. After the adhesive layer is allowed to dry (e.g., by allowing to stand or by flowing pressurized air over the disk), an imprinting process may be used to form a patterned layer on the adhesion layer, as indicated in step 108.

This dip coating process advantageously allows rapid coating of both sides simultaneously, while substantially eliminating problems associated with contamination of the disk that occurs during single sided coating processes (e.g., spin coating processes). This process is also easily implemented and allows for high throughput.

Disks coated with adhesion layers by the method described in FIG. 10 were prepared, and a thickness of the adhesion layer was optically measured (equipment by Metrosol, Austin, Tex.) at 76 locations on each side of the disk. As seen by the average results in Table I a thickness of adhesion layers on a double-sided disk is between about 1 nm and about 5 nm, or between about 2 nm and about 4 nm. In some cases, a thickness of the adhesion layer is less than about 3 nm. A standard deviation of the thickness of the adhesion layers is between about 0.5 and 1.5 nm or about 1 nm.

TABLE I
Thickness of dip-coated adhesion layer

| | Average Adhesion | Standard deviation |
|---|---|---|
| Disk | Layer Thickness (nm) | (nm) |
| 1 (side A) | 2.8 | 1.0 |
| 1 (side B) | 3.3 | 1.1 |
| 2 (side A) | 2.6 | 1.0 |
| 2 (side B) | 2.6 | 1.0 |

The shear test described herein was used to test adhesion between a solidified imprint resist and two media disks with a tantalum intermediate layer. The measured adhesion forces are shown in Table II below.

TABLE II
Shear test results for tantalum-coated disks

| | Adhesion Force |
|---|---|
| Disk | [lbf] |
| 1 | 45.2 |
| 2 | 49.5 |

Further modifications and alternative embodiments of various aspects will be apparent to those skilled in the art in view of this description. Accordingly, this description is to be construed as illustrative only. It is to be understood that the forms shown and described herein are to be taken as examples of embodiments. Elements and materials may be substituted for those illustrated and described herein, parts and processes may be reversed, and certain features may be utilized independently, all as would be apparent to one skilled in the art after having the benefit of this description. Changes may be made in the elements described herein without departing from the spirit and scope as described in the following claims.

What is claimed is:

1. A method of coating a double-sided disk, the method comprising:
immersing a double-sided disk in a liquid adhesive composition, the double-sided disk comprising a carbon overcoating on both sides of the disk;
removing the double-sided disk from the liquid adhesive composition; and
drying the adhesive composition to form a first adhesion layer adhered directly to the carbon overcoating on a first side of the disk and a second adhesion layer adhered directly to the carbon overcoating on a second side of the disk.

2. The method of claim 1, further comprising:
disposing a first polymerizable material on the first adhesion layer;
contacting the first polymerizable material with an imprint lithography template;
polymerizing the first polymerizable material on the first adhesion layer to form a first patterned layer adhered to the first adhesion layer; and
separating the imprint lithography template from the first patterned layer.

3. The method of claim 1, wherein the carbon overcoating comprises amorphous-hydrogenated carbon (CHₓ) or amorphous-nitrogenated carbon (CNₓ).

4. The method of claim 1, wherein the adhesive composition comprises a multi-functional reactive compound, and the multi-functional reactive compound comprises a linker group and two or more functional groups.

5. The method of claim 4, wherein the functional groups are independently selected from the group consisting of carboxy, epoxy, acrylic, hydroxy, and methoxy groups.

6. The method of claim 4, wherein the multi-functional reactive compound adheres to the carbon overcoating by covalent bonding.

7. The method of claim 6, wherein the multi-functional reactive compound comprises a carboxy group, and the multi-functional reactive compound adheres to the carbon overcoating by covalent bonding through the carboxy group.

8. The method of claim 4, wherein the multi-functional reactive compound adheres to the first polymerizable material by covalent bonding.

9. The method of claim 8, wherein the multi-functional reactive compound comprises an acrylic group or a methacrylic group, and the multi-functional reactive compound adheres to the first polymerizable material by covalent bonding through the acrylic group or the methacrylic group.

10. The method of claim 4, wherein the linker group is —CH₂—.

11. The method of claim 1, wherein a thickness of the first and second adhesion layers is between about 1 nm and about 5 nm, and a standard deviation of a thickness of the first and second adhesion layers is between about 0.5 nm and about 1.5 nm.

12. A method of coating a double-sided disk, the method comprising:
immersing a double-sided disk in a liquid adhesive composition, the double-sided disk comprising an intermediate layer over a carbon overcoating on both sides of the disk;
removing the double-sided disk from the liquid adhesive composition; and
drying the adhesive composition to form a first adhesion layer adhered directly to the intermediate layer on a first side of the disk and a second adhesion layer adhered directly to the intermediate layer on a second side of the disk.

13. The method of claim 12, further comprising:
disposing a first polymerizable material on the first adhesion layer;
contacting the first polymerizable material with an imprint lithography template;
polymerizing the first polymerizable material on the first adhesion layer to form a first patterned layer adhered to the first adhesion layer; and
separating the imprint lithography template from the first patterned layer.

14. The method of claim 12, wherein the intermediate layer comprises Ta, Si₃N₄, SiO₂, Cr, TiW, TiCr, Ru, SiN, or a combination thereof.

15. The method of claim 12, wherein the adhesive composition comprises a multi-functional reactive compound, and the multi-functional reactive compound comprises a linker group and two or more functional groups.

16. The method of claim 15, wherein the functional groups are independently selected from the group consisting of carboxy, epoxy, acrylic, hydroxy, and methoxy groups.

17. The method of claim 15, wherein the multi-functional reactive compound adheres to the intermediate layer by covalent bonding.

18. The method of claim 17, wherein the multi-functional reactive compound comprises a carboxy group, and the multi-functional reactive compound adheres to the intermediate layer by covalent bonding through the carboxy group.

19. The method of claim 15, wherein the multi-functional reactive compound adheres to the first polymerizable material by covalent bonding.

20. The method of claim 19, wherein the multi-functional reactive compound comprises an acrylic group or a methacrylic group, and the multi-functional reactive compound adheres to the first polymerizable material by covalent bonding through the acrylic group or the methacrylic group.

21. The method of claim 12, wherein a thickness of the first and second adhesion layers is between about 1 nm and about 5 nm, and a standard deviation of a thickness of the first and second adhesion layers is between about 0.5 nm and about 1.5 nm.

22. The method of claim 12, wherein the intermediate layer is tantalum, and an adhesive force between a solidified imprint resist the tantalum intermediate layer as measured in a shear test exceeds 45 lbf.

23. A double-sided disk comprising a carbon overcoating on each side of the disk, and an adhesion layer formed by dip coating, the adhesion layer directly adhered to each carbon overcoating, wherein a thickness of each adhesion layer is between 2 nm and 4 nm.

24. A method of coating a mesa on an imprint lithography template, the method comprising:
cleaning the surface of the template;
applying adhesive material to the mesa, such that the surface of the mesa and a surrounding portion of the template are substantially covered by the adhesive material;
allowing the template to remain substantially motionless for a length of time, during which time some of the adhesive material forms covalent bonds with the surface of the template, including the mesa;
rinsing a portion of the adhesive material from the template with a solvent, wherein rinsing comprises spinning the template; and
drying the template.
